(19) United States
(12) Patent Application Publication
(10) Pub. No.: US 2018/0132104 A1
(43) Pub. Date: May 10, 2018

(54) PREVENTING MOBILE PHONE ACCESSING WHEN IT IS IN UNLOCKED STATE

(71) Applicant: CA, Inc., New York, NY (US)

(72) Inventors: Narendra DHULIPALLA, Hyderabad (IN); Madhusudhan GANDA, Thyagaraja Nagar (IN); Sumit GUPTA, Bangalore (IN); Kiran Kumar B.S., Thyagaraja Nagar (IN); Swapnel SHRIVASTAVA, Bommanahalli (IN); Ramanuja CHARYULU, East Setauket, NY (US)

(73) Assignee: CA, Inc.

(21) Appl. No.: 15/347,397

(22) Filed: Nov. 9, 2016

(51) Int. Cl. H04W 12/08; H04W 12/06; H04L 29/06

(52) U.S. Cl. CPC H04W 12/08; H04L 63/0861; H04W 12/06

(57) ABSTRACT

A method includes determining that an operator biometric does not match any of a plurality of biometrics. The method further includes wherein the plurality of biometrics may be based on a user's interaction with a mobile device. The method further includes wherein the operator biometric may be based on an operator's interaction with the mobile device while the mobile device is in an unlocked state. The method further includes wherein the unlocked state may be associated with a set of mobile device features that are enabled. The method further includes, in response to determining that the operator biometric does not match any of the plurality of biometrics, transitioning the mobile device to a locked state that disables one or more mobile device features from the set that is enabled when the mobile device is in the unlocked state.

### BACKGROUND

The present disclosure relates to device security, and, more specifically, to systems and methods for securing an unlocked mobile device from an unauthorized user.

Mobile electronic devices provide a user with access to computing capabilities even as the user moves about various locations. Examples of mobile electronic devices include mobile phones, media players, laptops, tablets, personal digital assistants (PDAs), or hybrid devices that include functionality of multiple devices of this type. Devices such as mobile phones and tablets have become pervasive in society today. These devices are utilized for both business and personal endeavors. In addition, most of these devices have access to sensitive information that should be protected. If a device is misplaced while in an unlocked state, an unauthorized third party may have access to unprotected sensitive information.

Systems and methods described herein provide a user with the ability to secure an unlocked mobile device from an authorized user. The present disclosure describes a system and method for determining that an operator biometric does not match any of a plurality of biometrics. The operator biometric may be detected based on an operator's interaction with an unlocked mobile device. In response to determining that the operator biometric does not match any of the plurality of biometrics, systems and methods described herein enable transitioning the mobile device to a locked state.

### BRIEF SUMMARY

According to an aspect of the present disclosure, a method may include several processes. In particular, the method may include determining that an operator biometric does not match any of a plurality of biometrics. The plurality of biometrics may be based on a user's interaction with a mobile device. The operator biometric may be based on an operator's interaction with the mobile device while the mobile device is in an unlocked state. The unlocked state may be associated with a set of mobile device features that are enabled. The method may further include, in response to determining that the operator biometric does not match any of the plurality of biometrics, transitioning the mobile device to a locked state that disables one or more mobile device features from the set that is enabled when the mobile device is in the unlocked state.

Other features and advantages will be apparent to persons of ordinary skill in the art from the following detailed description and the accompanying drawings.

### BRIEF DESCRIPTION OF THE DRAWINGS

Aspects of the present disclosure are illustrated by way of example and are not limited by the accompanying figures with like references indicating like elements of a non-limiting embodiment of the present disclosure.

FIG. 1 is a schematic representation of an authorization system ecosystem of a non-limiting embodiment of the present disclosure.

FIG. 2 is a schematic representation of an authorization system configured to interact with the authorization system ecosystem.

FIG. 3 illustrates a biometric received by the authorization system on a device according to a non-limiting embodiment of the present disclosure.

FIG. 4 illustrates a biometric received by the authorization system on a device according to a non-limiting embodiment of the present disclosure.

FIG. 5 illustrates a biometric received by the authorization system on a device according to a non-limiting embodiment of the present disclosure.

FIG. 6 is a flow chart for a method for comparing biometrics and transitioning a mobile device according to a non-limiting embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or in a combined software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would comprise the following: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. In the context of this document, a computer readable storage medium may be any tangible medium able to contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take a variety of forms comprising, but not limited to, electro-magnetic, optical, or a suitable combination thereof. A computer readable signal medium may be a computer readable medium that is not a computer readable storage medium and that is able to communicate, propagate, or transport a program for use by or in connection with an instruction execution system, apparatus, or device. Program code embodied on a computer readable signal medium may be transmitted using an appropriate medium, comprising but not limited to wireless, wireline, optical fiber cable, RF, etc., or any suitable combination of the foregoing.

Computer program code for carrying out operations for aspects of the present disclosure may be written in a combination of one or more programming languages, comprising an object oriented programming language such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider) or in a cloud computing environment or offered as a service such as a Software as a Service (“SaaS”).

Aspects of the present disclosure are described herein with reference to flowchart illustrations and/or block diagrams of methods, apparatuses (e.g., systems), and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks. Each activity in the present disclosure may be executed on one, some, or all of one or more processors. In some non-limiting embodiments of the present disclosure, different activities may be executed on different processors.

These computer program instructions may also be stored in a computer readable medium that, when executed, may direct a computer, other programmable data processing apparatus, or other devices to function in a particular manner, such that the instructions, when stored in the computer readable medium, produce an article of manufacture comprising instructions which, when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices to produce a computer implemented process, such that the instructions which execute on the computer or other programmable apparatus provide processes for implementing the functions/acts specified in the flowchart and/or block diagram block or blocks.

While certain example systems and methods disclosed herein may be described with reference to route determination for mobile devices, systems and methods disclosed herein may be related to any field. Moreover, certain examples disclosed herein may be described with respect to consumer or business electronics, or any other field that may involve authorization determination components. Certain embodiments described in the present disclosure are merely provided as example implementations of the processes described herein.

Protecting access to sensitive information on a mobile device is an issue for all developed nations. As mobile devices become cheaper and more pervasive, security becomes increasingly important. Should a user of a mobile device lose possession of the mobile device while it is in an unlocked state, there is little to no protection from a third party accessing sensitive information on the unlocked mobile device. Systems and methods disclosed herein may determine that an unauthorized third party is attempting to use the unlocked mobile device. Further, systems and methods disclosed herein may transition the mobile device to a locked state in response to determining that a biometric of a third party does not match a plurality of biometrics of the true owner of the mobile device.

The teachings of the present disclosure may reference specific example “device.” For example, an “device” can include may refer to a smartphone, Global Positioning System (GPS) device, satellite communication terminal, radio communication terminal, or any other device capable of storing or accessing sensitive information. For example, a mobile device may be equipped with sensors, such as an accelerometer and GPS system, for accessing and interfacing with applications or websites containing sensitive information. Any device with such capabilities is contemplated within the scope of the present disclosure.

In a first example, systems and methods disclosed herein may determine, using a processor, that an operator biometric does not match any of a plurality of biometrics. Further, the plurality of biometrics may be based on a user's interaction with a mobile device. In addition, the operator biometric may be based on an operator's interaction with the mobile device while the mobile device is in an unlocked state. The unlocked state may be associated with a set of mobile device features that are enabled. Systems and methods disclosed herein may, in response to determining that the operator biometric does not match any of the plurality of biometrics, transition the mobile device, using the processor, to a locked state that disables one or more mobile device features from the set that is enabled when the mobile device is in the unlocked state.

In a second example, non-limiting embodiments of the present disclosure may include a processing system configured to perform processes including determining a plurality of biometrics for a user based on the user's interactions with a mobile device, and storing the plurality of biometrics in a local database of the mobile device. The processing system may be configured to perform processes including determining that the mobile device is in an unlocked state, wherein the unlocked state may be associated with a set of mobile device features that are enabled. The processing system may be configured to perform processes including determining an operator biometric based on an operator's interactions with the mobile device while the mobile device is in the unlocked state. The processing system may be configured to perform processes including determining that the operator biometric does not match any of the plurality of biometrics. In addition, the processing system may be configured to perform processes including, in response to determining that the operator biometric does not match any of the plurality of biometrics, transitioning the mobile device to a locked state that disables one or more mobile device features from the set that is enabled when the mobile device is in the unlocked state.

In a third example, systems and methods disclosed herein may determine a plurality of biometrics for a user based on the user's interactions with a mobile device. Systems and methods disclosed herein may also determine a timing biometric comprising an average time of the user's interaction with a display screen of the mobile device, wherein the plurality of biometrics comprises the timing biometric. Systems and methods disclosed herein may store the plurality of biometrics in a local database on the mobile device, and determine that the mobile device is in an unlocked state, wherein the unlocked state may be associated with a set of mobile device features that are enabled. Systems and methods disclosed herein may determine an operator biometric based on an operator's interactions with the mobile device while the mobile device is in the unlocked state. Further, systems and methods disclosed herein may determine that the operator biometric does not match any of the plurality of biometrics. In addition, systems and methods disclosed herein may, in response to determining that the operator biometric does not match any of the plurality of biometrics, transition the mobile device to a locked state that disables one or more mobile device features from the set that is enabled when the mobile device is in the unlocked state.

Some non-limiting implementations of the present disclosure may utilize GPS-enabled, Wi-Fi/Cellular transmitters, accelerometers, or any built-in capabilities that are attached to devices. Any portion of a mobile device may be used to detect and record a user biometric. For example, a pedometer application on the device may use an accelerometer to detect a walking biometric of a user. Devices may include mobile devices such as cell phones and laptops, as well as enabled vehicles.

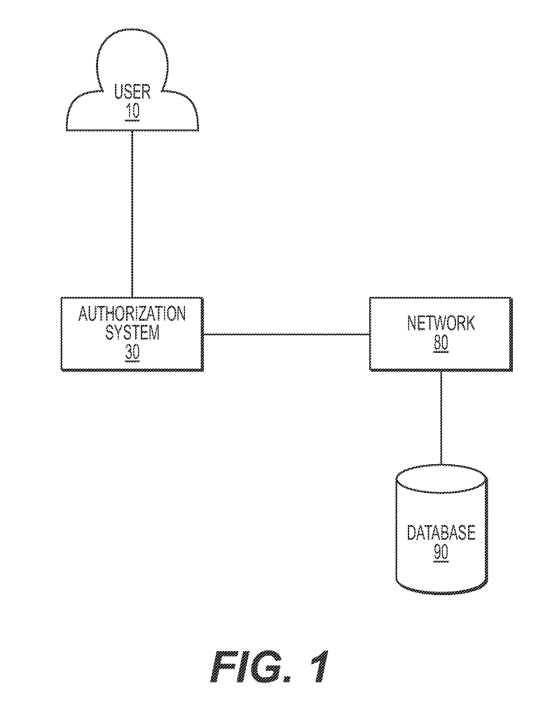

Referring now to FIG. 1, an authorization system ecosystem of a non-limiting embodiment of the present disclosure is illustrated. An authorization system 30 may communicate with a database 90 and user 10 via a network 80. In addition, authorization system 30 may directly communicate with user 10 when authorization system is installed on a device.

Network 80 may comprise one or more entities, which may be public, private, or community based. Network 80 may permit the exchange of information and services among users/entities that are connected to such network 80. In certain configurations, network 80 may be a local area network, such as an intranet. Further, network 80 may be a closed and/or private network/cloud in certain configurations, and an open network/cloud in other configurations. Network 80 may facilitate wired or wireless communications of information and provisioning of services among users that are connected to network 80.

Network 80 may comprise one or more clouds, which may be public clouds, private clouds, or community clouds. Each cloud may permit the exchange of information and the provisioning of services among devices and/or applications that are connected to such clouds. Network 80 may include a wide area network, such as the Internet; a local area network, such as an intranet; a cellular network, such as a network using CDMA, GSM, 3G, 4G, LTE, or other protocols; a machine-to-machine network, such as a network using the MQTT protocol; another type of network; or some combination of the aforementioned networks. Network 80 may be a closed, private network, an open network, or some combination thereof and may facilitate wired or wireless communications of information among devices and/or applications connected thereto.

Network 80 may include a plurality of devices, which may be physical devices, virtual devices (e.g., applications running on physical devices that function similarly to one or more physical device), or some combination thereof. The devices within network 80 may include, for example, one or more of general purpose computing devices, specialized computing devices, mobile devices, wired devices, wireless devices, passive devices, routers, switches, mainframe devices, monitoring devices, infrastructure devices, other devices configured to provide information to and/or receive information from service providers and users, and software implementations of such.

Mobile electronic devices may be part of a communication network such as a local area network, wide area network, cellular network, the Internet, or any other suitable network. A mobile electronic device may use a communication network to communicate with other electronic devices, for example, to access remotely-stored data, access remote processing power, access remote displays, provide locally-stored data, provide local processing power, or provide access to local displays. For example, networks may provide communication paths and links to servers, which may host applications, content, and services that may be accessed or utilized by users via mobile electronic devices. The content may include text, video data, audio data, user settings or other types of data. Networks may use any suitable communication protocol or technology to facilitate communication between mobile electronic devices, such as, for example, BLUETOOTH, IEEE WI-FI (802.11a/b/g/n/ac), or Transmission Control Protocol/Internet Protocol (TCP/IP).

In addition, authorization system 30 may use network 80 to communicate with a user 10. In some non-limiting embodiments of the present disclosure, user 10 may communicate with authorization system 30 via network 80 using a device such as, for example, a cellular phone, a tablet, a laptop, and other portable devices. In other non-limiting embodiments of the present disclosure, authorization system 30 may be located on a device associated with user 10. Mobile devices may be powered by a mobile operating system, such as Apple Inc.'s iOS® mobile operating system or Google Inc.'s Android® mobile operating system, for example. In some non-limiting embodiments of the present disclosure, mobile devices may be enabled to determine biometrics of user 10 and provide such data to the authorization system 30 through direct communication or via the network 80. In some non-limiting embodiments, mobile devices may communicate with authorization system 30 using a cellular network, such as 3G or LTE, for example, or other communication protocols or methods, such as Wi-Fi or NFC, for example. Further, mobile devices may include one or more applications that provide a user interface, which may display alerts, alarms, and/or notifications disclosed herein, and which may provide one or more options for interaction with authorization system 30.

The authorization system environment may also include a database 90 which may include, for example, additional servers, data storage, and resources. Authorization system 30 may receive additional data or biometrics from database 90. Authorization system 30 may also store biometrics, user history, access data, sensitive information, and notifications and any information regarding determining and comparing biometrics on the database 90. Database 90 may be any conventional database or data infrastructure. For example, database 90 may include scaled out data architectures (i.e., Apache Hadoop) and/or persistent, immutable stores/logging systems.

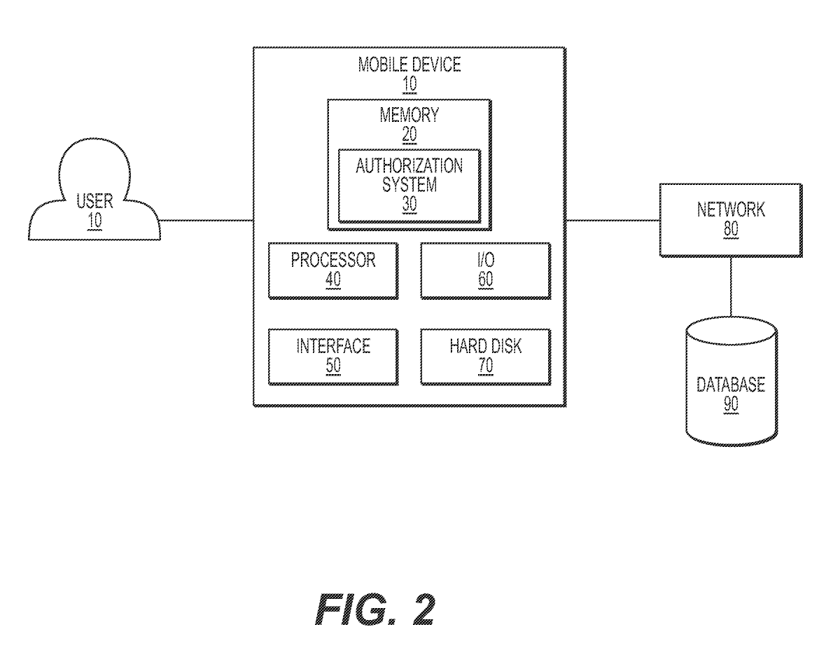

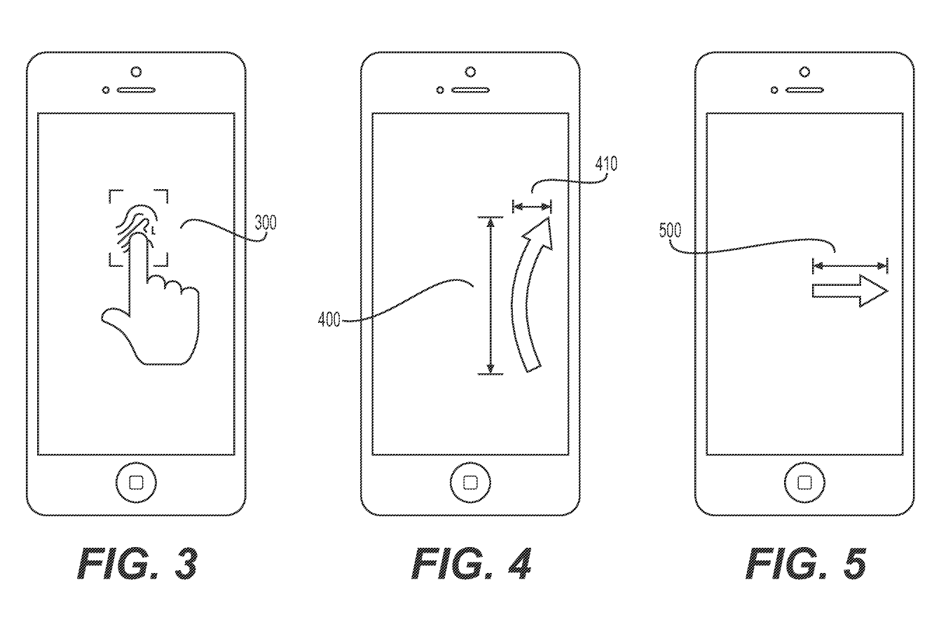

Referring to FIG. 2, the authorization system 30 of a non-limiting embodiment of the present disclosure is displayed. Mobile device 10 may reside on one or more networks. Mobile device 10 may be any device that may determine a user biometric. Mobile device 10 may comprise a memory 20, a central processing unit, an input and output (“I/O”) device 60, a processor 40, an interface 50, and a hard disk 70. Memory 20 may store computer-readable instructions that may instruct mobile device 10 to perform certain processes. In particular, memory 20 may store a plurality of application programs that are under development. Memory 20 also may store a plurality of scripts that include one or more testing processes for evaluation of the applications. When computer-readable instructions, such as an application program or a script, are executed by the CPU, the computer-readable instructions stored in memory 20 may instruct the CPU to perform a plurality of functions. Examples of such functions are described below with respect to FIGS. 3-6. In some non-limiting embodiments of the present disclosure, the CPU may be authorization system 30. In some implementations, when computer-readable instructions, such as an application program or a script, are executed by the authorization system 30, the computer-readable instructions stored in memory 20 may instruct the authorization system 30 to perform a plurality of functions.

I/O device 60 may receive data from network 80, a local database, data from other devices and sensors connected to mobile device 10, and input from a user and provide such information to the authorization system 30. I/O device 60 may transmit data to network 80, database 90, and/or a local database. I/O device 60 may transmit data to other devices connected to mobile device 10, and may transmit information to a user (e.g., display the information, send an e-mail, make a sound). Further, I/O device 60 may implement one or more of wireless and wired communication between mobile device 10 or authorization system 30 and other devices within or external to network 80. I/O device 60 may receive one or more of data from another server or a network 80. The mobile device 10 may be a processing system, a server, a plurality of servers, or any combination thereof. In addition, I/O device 60 may communicate received input or data from user 10 to authorization system 30.

Authorization system 30 may be located on the cloud or on an external network. Authorization system 30 may be SaaS or entirely located on the mobile device 10. In some non-limiting embodiments, authorization system 30 may be partially located on a mobile device and partially on the cloud or a network, or any combination thereof. Furthermore, some non-limiting configurations of authorization system 30 may be located exclusively on a user's device, such as, for example a mobile device or tablet. Authorization system 30 may also be accessed by a user on mobile device 10 such as any type of computing device, for example, a mobile telephone or a tablet.

Further referring to FIG. 2, in some non-limiting embodiments of the present disclosure, a mobile application may be installed on the mobile device 10. The mobile application may facilitate communication with authorization system 30, database 90, or any other entity. In some non-limiting embodiments, the mobile application on mobile device 10 may track, record, and report information to the authorization system 30, such as, for example, user biometrics. In systems and methods of the present disclosure, mobile device 10 may not be connected to a data network while in communication with authorization system 30.

In some non-limiting embodiments, mobile device 10 may store biometric information or data locally on the mobile device 10. In some non-limiting embodiments of the present disclosure, a mobile application may work with authorization system 30 to manage biometrics, data, and corresponding user information on the mobile device 10. The mobile application may maintain an offline copy of all information. In some systems and methods of the present disclosure, authorization system 30 may rely on information in a cloud database. Authorization system 30 may, in some non-limiting embodiments, store biometrics, user data, and any information in the cloud database or on database 90.

FIGS. 3-5 illustrate biometrics received by the authorization system on a device according to a non-limiting embodiment of the present disclosure. Authorization system 30 may determine a plurality of biometrics for a user based on the user's interactions with a mobile device 10. For example, authorization system 30 may determine a timing biometric based on an average time of the user's interaction with a display screen of the mobile device 10. Authorization system 30 may use any capability of the mobile device 10 to measure a user biometric.

In some non-limiting embodiments, authorization system 30 may rely on any sensor of the mobile device 30 to determine a biometric, such as, for example, gyroscope, accelerometer, microphone, light sensor, proximity sensor, infrared LED detector, IR light detector, linear acceleration sensor, gravity sensor, orientation sensor, camera sensor, magnetometer, barometer, thermometer, touch sensor, 3D touch sensor, location sensor (e.g., GPS), NFC sensor, Bluetooth sensor, input sensor, fingerprint sensor, biometric sensor, heart rate monitor, air humidity sensor, pedometer, and the like. Any single sensor or combination of sensors may be used to determine or develop a biometric identification for the true user of the mobile device 10. In addition, authorization system 30 may determine a movement biometric based on movement of the mobile device 10 determined by any sensors on the mobile device 10.

In some non-limiting embodiments of the present disclosure, authorization system 30 may determine or develop biometrics for multiple authorized users of mobile device 10. Authorization system 30 may determine a plurality of second biometrics for a second user based on the second user's interactions with the mobile device. In addition, authorization system 30 may determine that the operator biometric does not match any of a plurality of second biometrics that are based on a second user's interactions with the mobile device. Further, authorization system 30 may transition the mobile device 10 from an unlocked state to a locked state in response to determining that the operator biometric does not match any of the plurality of second biometrics.

For example, the accelerometer may be used as a pedometer to measure the gait of a user of the mobile device 10. Authorization system 30 may store a gait biometric of the true owner of the phone. Authorization system 30 may also compare an operator's gait biometric to the gait biometric of the true owner of the phone to determine if they match. In some non-limiting embodiments, authorization system 30 may use an accelerometer to determine pitch, roll, and yaw of the mobile device 10 in the operator's hands. Authorization system 30 may determine an orientation biometric based on the true user's interaction with the pitch, roll, and/or yaw of the mobile device 10. For example, authorization system 30 may determine a user biometric based on the average pitch of a display screen of the mobile device 10 when the user is in a position (e.g., upright or prone position) or when a user is using a certain application. Authorization system 30 may determine user biometrics based on behavioral patterns or how the mobile device 10 is held or used.

In some non-limiting embodiments, authorization system 30 may determine a user biometric based on an interaction characteristic indicative of a manner in which the user typically interacts with the mobile device 10. An interaction characteristic may include an average time between user inputs. For example, authorization system 30 may detect a plurality of user inputs into the mobile device 10 via any of a number of sensors. Authorization system 30 may determine a pattern or average of the inputs to determine a user biometric. In some non-limiting embodiments of the present disclosure, authorization system 30 may determine a pattern in which the user typically accesses applications on the mobile device 10.

Authorization system 30 may determine a displacement biometric based on data received from any sensor of the mobile device 10. In some non-limiting embodiments, authorization system 30 may be able to determine a pattern of displacement of the mobile device 10 by the user. For example, authorization system may determine a displacement biometric based on an average velocity determined from the user moving the mobile device 10.

As illustrated in FIG. 3, authorization system 30 may determine a fingerprint biometric 300 for the true user of the mobile device 10. Authorization system 30 may determine a biometric for each finger of a true user, or any other bodily appendage that may be used for identification and authorization. In some non-limiting embodiments, authorization system 30 may detect a user's fingerprint on a display screen of the mobile device 10 and record the fingerprint as a fingerprint biometric 300. In addition, authorization system 30 may use a sensor anywhere on the mobile device 10 to detect a fingerprint biometric. For example, authorization system 30 may determine a user's fingerprint biometric on the side of the mobile device 10 opposite the display screen.

If a user misplaces the mobile device 10 and an unauthorized third party touches the display screen of the mobile device 10 in an unlocked state with a finger, authorization system 30 may compare the third party's fingerprint to the user's fingerprint biometric 300 to determine if they match. In some situations, lack of a match may indicate that the third party is not the user. Upon determining that the third party's fingerprint does not match the user's fingerprint biometric 300, authorization system 30 may transition the mobile device 10 to a locked state, thereby disabling features that are enabled when the mobile device 10 is in an unlocked state. In some non-limiting embodiments of the present disclosure, authorization system 30 may choose from a plurality of actions upon determining a third party's biometric fails to match a user biometric.

As illustrated in FIGS. 4 and 5, authorization system 30 may determine interaction biometrics of a user interacting with a display screen of mobile device 10. In some non-limiting embodiments of the present disclosure, authorization system 30 may determine an average interaction of the user's finger with a display screen of the mobile device. Authorization system 30 may determine a length 400 and a width 410 of a user's interaction with the display screen of the mobile device 10. Authorization system 30 may average a plurality of swiping interactions to determine an interaction biometric.

In addition, as illustrated in FIG. 5, authorization system 30 may determine an interaction biometric using a width 500 of a user's interaction with the display screen of the mobile device 10. Further, authorization system 30 may average a plurality of swiping interactions to determine an interaction biometric of the user. In some non-limiting embodiments, authorization system 30 may develop a user biometric based on any user interaction with the display screen of the mobile device. For example, authorization system 30 may average a user's common tapping interaction with the display screen of mobile device 10 to develop a tapping biometric.

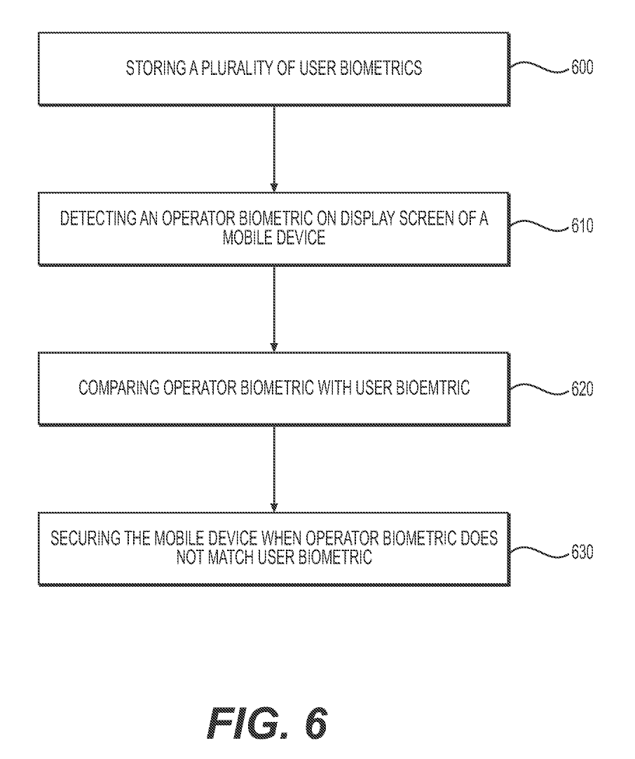

FIG. 6 is a flow chart for a method for comparing biometrics and transitioning a mobile device according to a non-limiting embodiment of the present disclosure. In some non-limiting embodiments of the present disclosure, authorization system 30 may determine multiple biometrics for a user based on the user's interactions with a mobile device. In addition, as shown in step 600, authorization system 30 may store the multiple biometrics in a local database on the mobile device 10, in the database 90, or in a cloud database. Authorization system 30 may store biometrics for multiple authorized users of the mobile device 10.

In step 610, authorization system 30 may detect an operator biometric associated with the mobile device 10. In some non-limiting embodiments, the operator biometric may be detected on a display screen of mobile device 10. Authorization system 30 may determine that the mobile device 10 is in an unlocked state prior to detecting an operator biometric. The unlocked state may be associated with a set of mobile device features that are enabled.

In step 620, authorization system 30 may compare the detected operator biometric to the multiple user biometrics previously determined. In some non-limiting embodiments, authorization system 30 may compare a single or multiple operator biometrics to a plurality of biometrics of the true owner of the mobile device 10.

In step 630, authorization system 30 may determine if the operator biometric matches any of the multiple user biometrics. If an operator biometric does not match any of a plurality of biometrics of the true user, authorization system 30 may perform a multitude of operations. In some non-limiting embodiments, authorization system 30 may determine that a manner in which the operator is interacting with the mobile device 10 differs from the manner in which the user typically interacts with the mobile device 10.

In response to determining that the operator biometric does not match any of the plurality of biometrics, authorization system 30 may transition the mobile device to a locked state that disables one or more mobile device features from the set that is enabled when the mobile device is in the unlocked state. In some non-limiting embodiments, authorization system 30 may lock out the operator and request additional identification actions before unlocking the mobile device 10. In other non-limiting embodiments, authorization system 30 may back up all sensitive information on the mobile device 10 and/or remove all sensitive information from the mobile device 10. In addition, authorization system 30 may send a notification or indication to another device associated with the true user. For example, in some non-limiting embodiments authorization system 30 may send a notification email or notification to an account of the true user. In some cases authorization system 30 may keep a log of unmatching biometrics.

In some non-limiting embodiments, authorization system 30 may be configured to lock the mobile device 10 upon any movement of the mobile device 10 while in the unlocked state. In other configurations, authorization system 30 may be configured to lock the mobile device 10 upon completion of a predetermined time of inactivity.

The flowcharts and diagrams in FIGS. 1-6 illustrate the architecture, functionality, and operation of possible implementations of systems, methods, and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, “each” means “each and every” or “each of a subset of every,” unless context clearly indicates otherwise.

The corresponding structures, materials, acts, and equivalents of means or step plus function elements in the claims below are intended to comprise any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. For example, this disclosure comprises possible combinations of the various elements and features disclosed herein, and the particular elements and features presented in the claims and disclosed above may be combined with each other in other ways within the scope of the application, such that the application should be recognized as also directed to other embodiments comprising other possible combinations. The aspects of the disclosure herein were chosen and described in order to best explain the principles of the disclosure and the practical application and to enable others of ordinary skill in the art to understand the disclosure with various modifications as are suited to the particular use contemplated.

1. A method, comprising:
detecting a plurality of user inputs into a mobile device;
determining an average time between the user inputs;
determining, using a processor, that an operator biometric does not match any of a plurality of biometrics, the plurality of biometrics based on a user's interaction with a mobile device, the operator biometric based on an operator's interaction with the mobile device while the mobile device is in an unlocked state, the unlocked state associated with a set of mobile device features that are enabled;
wherein the operator biometric comprises the average time between the user inputs; and
in response to determining that the operator biometric does not match any of the plurality of biometrics, transitioning the mobile device, using the processor, to a locked state that disables one or more mobile device features from the set that is enabled when the mobile device is in the unlocked state.

2. The method of claim 1, wherein the plurality of biometrics comprises an interaction characteristic indicative of a manner in which the user typically interacts with the mobile device and the operator biometric further comprises an average pitch of the display screen when the user is using a certain application.

3. The method of claim 2, wherein determining that the operator biometric does not match any of the plurality of biometrics comprises determining that a manner in which the operator is interacting with the mobile device differs from the manner in which the user typically interacts with the mobile device, and wherein the operator biometric comprises the average pitch of the display screen when the user is in an upright position.

4. The method of claim 3, wherein the interaction characteristic comprises
a pattern in which the user typically accesses applications on the mobile device.

5. The method of claim 1, wherein transitioning the mobile device to a locked state comprises:
sending a notification to another device associated with the user.

6. The method of claim 1, wherein the plurality of biometrics comprises a displacement biometric based on an average velocity determined from the user moving the mobile device.

7. (canceled)

8. The method of claim 1, further comprising:
determining, using the processor, a plurality of second biometrics for a second user based on the second user's interactions with the mobile device;
determining, using the processor, that the operator biometric does not match any of a plurality of second biometrics that are based on a second user's interactions with the mobile device, and wherein said transitioning is also in response to determining that the operator biometric does not match any of the plurality of second biometrics.

9. The method of claim 1, wherein the plurality of biometrics are stored in a local database on the mobile device, and the plurality of biometrics further comprise roll and yaw of the mobile device.

10. (canceled)

11. A computer system comprising:
a processor; and
a non-transitory, computer-readable storage medium storing computer-readable instructions that when executed by the processor cause the computer to perform:
determining a plurality of biometrics for a user based on the user's interactions with a mobile device;
storing the plurality of biometrics in a local database of the mobile device;
determining that the mobile device is in an unlocked state, the unlocked state being associated with a set of mobile device features that are enabled;
determining an operator biometric based on an operator's interactions with the mobile device while the mobile device is in the unlocked state, wherein determining the operator biometric comprises:
detecting a non-linear swipe on a screen of the mobile device;
determining an overall length and an overall width that entirely encompasses the non-linear swipe;
determining that the operator biometric does not match any of the plurality of biometrics, wherein the operator biometric includes the overall length and the overall width that entirely encompasses the non-linear swipe; and
in response to determining that the operator biometric does not match any of the plurality of biometrics, transitioning the mobile device to a locked state that disables one or more mobile device features from the set that is enabled when the mobile device is in the unlocked state.

12. The system of claim 11, wherein the instructions, when executed by the processor, further cause the computer to perform:
determining an average interaction of the user's finger with a display screen of the mobile device, wherein the plurality of biometrics comprises the average interaction of the user's finger with the display screen of the mobile device.

13. The system of claim 11, wherein the instructions, when executed by the processor, further cause the computer to perform:
determining fingerprint biometrics of the user by scanning the user's fingerprints on a sensor of the mobile device, wherein the plurality of biometrics comprises fingerprint biometrics of the user.

14. (canceled)

15. The system of claim 11, wherein transitioning the mobile device to a locked state comprises:
sending a notification to another device associated with the user.

16. The system of claim 11, wherein the instructions, when executed by the processor, further cause the computer to perform:
determining a displacement biometric comprising an average velocity of the user moving the mobile device, wherein the plurality of biometrics comprises the displacement biometric.

17. The system of claim 16, wherein the instructions, when executed by the processor, further cause the computer to perform:
receiving data from an accelerometer of the mobile device; and
determining the displacement biometric based on the data received from the accelerometer of the mobile device.

18. The system of claim 11, wherein the instructions, when executed by the processor, further cause the computer to perform:
determining a plurality of second biometrics for a second user based on the second user's interactions with the mobile device;
determining that the operator is not the second user by determining that the operator biometric does not match any of the plurality of second biometrics.

19. The system of claim 11, wherein the instructions, when executed by the processor, further cause the computer to perform:
determining a timing biometric comprising an average time of the user's interaction with a display screen of the mobile device, wherein the plurality of biometrics comprises the timing biometric.

20. A non-transitory computer-readable medium having instructions stored thereon that are executable by a computing system to perform operations comprising:
determining a plurality of biometrics for a user based on the user's interactions with a mobile device;
determining a timing biometric comprising an average time of the user's interaction with a display screen of the mobile device, wherein the plurality of biometrics comprises the timing biometric;
storing the plurality of biometrics in a local database on the mobile device;
determining that the mobile device is in an unlocked state, the unlocked state being associated with a set of mobile device features that are enabled;
determining an operator biometric based on an operator's interactions with the mobile device while the mobile device is in the unlocked state, wherein determining the operator biometric comprises:
detecting a non-linear swipe on a screen of the mobile device; and
determining an overall length and an overall width that entirely encompasses the non-linear swipe;
determining that the operator biometric does not match any of the plurality of biometrics, wherein the operator biometric includes the overall length and the overall width that entirely encompasses the non-linear swipe; and
in response to determining that the operator biometric does not match any of the plurality of biometrics, transitioning the mobile device to a locked state that disables one or more mobile device features from the set that is enabled when the mobile device is in the unlocked state.

21. The non-transitory computer readable medium of claim 20, wherein the instructions stored thereon are executable by a computing system to perform further operations comprising:
detecting a plurality of user inputs into a mobile device;
determining an average time between the user inputs; and
wherein the operator biometric further comprises the average time between the user inputs.

22. The method of claim 1, further comprising:
detecting a non-linear swipe on a screen of the mobile device;
determining an overall length and an overall width that entirely encompasses the non-linear swipe;
wherein the operator biometric further includes the overall length and the overall width that entirely encompasses the non-linear swipe.

23. The system of claim 11, wherein the instructions, when executed by the processor, further cause the computer to perform:
detecting a plurality of user inputs into a mobile device;
determining an average time between the user inputs; and
wherein the operator biometric further comprises the average time between the user inputs.
